(19) United States
(12) Patent Application Publication
(10) Pub. No.: US 2015/0311977 A1
(43) Pub. Date: Oct. 29, 2015

(54) METHODS AND APPARATUS FOR CONFIGURING AN IMAGE SENSOR FOR DECODING HIGH FREQUENCY VISIBLE LIGHT COMMUNICATION SIGNALS

(71) Applicant: QUALCOMM Incorporated, San Diego, CA (US)

(72) Inventors: Aleksandar JOVICIC, Jersey City, NJ (US); Kumar APPAIAH, Piscataway, NJ (US); Junyi LI, Chester, NJ (US)

(73) Assignee: QUALCOMM Incorporated, San Diego, CA (US)

(21) Appl. No.: 14/108,174

(22) Filed: Dec. 16, 2013

(51) Int. Cl. H04B 10/116; H04B 10/69; H04N 5/235; H04N 5/374; H04N 5/232; H04N 5/225; H04B 7/26; H04N 5/353

(52) U.S. Cl. CPC H04B 10/116; H04B 7/26; H04B 10/691; H04N 5/3535; H04N 5/374; H04N 5/23293; H04N 5/2252; H04N 5/235; H04N 2101/00

(57) ABSTRACT

A method, an apparatus, and a computer-readable medium for configuring an image sensor for processing a visible light communication (VLC) signal are provided. The apparatus instructs the image sensor to operate at a first exposure setting, the first exposure setting lower than a second exposure setting for capturing a photographic image, captures, via the image sensor, at least one VLC signal frame at the first exposure setting, detects at least one communication symbol included in the at least one captured VLC signal frame, and decodes a message associated with the at least one VLC signal frame captured by the image sensor by decoding a number of detected communication symbols.

### BACKGROUND

1. Field

The present disclosure relates generally to a visible light communication (VLC) system, and more particularly, to configuring an image sensor for decoding VLC signals.

2. Background

Recently, interest in radio over fiber technologies complementary to Radio Frequency (RF) technologies has increased due to the exhaustion of RF band frequencies, potential crosstalk between several wireless communication technologies, increased demand for communication security, and the advent of an ultra-high speed ubiquitous communication environment based on various wireless technologies. Consequently, visible light wireless communication employing visible light LEDs has been developed to complement RF technologies.

Visible Light Communication (VLC) for transferring information by using visible light has advantages in that VLC enables communication through widely available bandwidth without regulation. In addition, because users can observe a location at which light corresponding to a VLC communication arrives, as well as a direction along which the light travels, information regarding coverage may be accurately ascertained. VLC can also offer reliable security and low power consumption. In light of these and other advantages, VLC can be applied in locations where the use of RF communications is prohibited, such as hospitals or airplanes, and can also provide additional information services through electronic display boards.

### SUMMARY

In an aspect of the disclosure, a method, a computer-readable medium, and an apparatus are provided. The apparatus configures an image sensor for processing a visible light communication (VLC) signal by instructing the image sensor to operate at a first exposure setting, the first exposure setting lower than a second exposure setting for capturing a photographic image, capturing, via the image sensor, at least one VLC signal frame at the first exposure setting, detecting at least one communication symbol included in the at least one captured VLC signal frame, and decoding a message associated with the at least one VLC signal frame captured by the image sensor by decoding a number of detected communication symbols.

In an aspect, the apparatus includes means for instructing the image sensor to operate at a first exposure setting, the first exposure setting lower than a second exposure setting for capturing a photographic image, means for capturing, via the image sensor, at least one VLC signal frame at the first exposure setting, means for detecting at least one communication symbol included in the at least one captured VLC signal frame, and means for decoding a message associated with the at least one VLC signal frame captured by the image sensor by decoding a number of detected communication symbols.

In another aspect, the apparatus includes a memory and at least one processor coupled to the memory and configured to instruct the image sensor to operate at a first exposure setting, the first exposure setting lower than a second exposure setting for capturing a photographic image, capture, via the image sensor, at least one VLC signal frame at the first exposure setting, detect at least one communication symbol included in the at least one captured VLC signal frame, and decode a message associated with the at least one VLC signal frame captured by the image sensor by decoding a number of detected communication symbols.

In a further aspect, a computer-readable medium for configuring an image sensor for processing a visible light communication (VLC) signal includes code for instructing the image sensor to operate at a first exposure setting, the first exposure setting lower than a second exposure setting for capturing a photographic image, code for capturing, via the image sensor, at least one VLC signal frame at the first exposure setting, code for detecting at least one communication symbol included in the at least one captured VLC signal frame, and code for decoding a message associated with the at least one VLC signal frame captured by the image sensor by decoding a number of detected communication symbols.

### BRIEF DESCRIPTION OF THE DRAWINGS

FIG. 1 is a diagram illustrating exposure control in a CMOS image sensor.

FIG. 2 is a diagram illustrating hardware units within a mobile device and a signal flow between the hardware units for enabling VLC decoding.

FIG. 3 is a flow chart of configuring an image sensor for processing a visible light communication (VLC) signal.

FIG. 4 is a data flow diagram illustrating the data flow between different modules/means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of communication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

A VLC system generally includes various VLC devices, such as a Base Station (BS) and a VLC terminal. The BS may include one or more light sources, such as an LED or a Laser Diode (LD), to perform an illuminating function and transmit data using visible light. The BS may further include a communication control device that processes data transmitted and received by the light source. The BS may also transmit data to and receive data from the VLC terminal. The VLC terminal may include a visible light transmission/reception module for transmitting data to and receiving data from the BS through the light source. The VLC terminal may be a portable terminal such as a cellular phone, a Personal Digital Assistant (PDA), a tablet device, etc., or a fixed terminal such as a desktop computer. The VLC terminal may also transmit data to and receive data from another VLC terminal by using visible light. VLC may also be used more efficiently in combination with a communication system using other wired/wireless communication media.

VLC signals may use light intensity modulation to convey information. VLC signals can be detected and decoded by a CMOS image sensor. However, default exposure settings for the image sensor may be designed for photography and not for VLC signal decoding. As such, the default exposure settings may cause a large amount of attenuation of high frequency VLC signals rendering the VLC signals undetectable. In the present disclosure, a method and apparatus is provided for adapting the exposure settings of the image sensor in order to detect high frequency VLC signals. The method and apparatus is beneficial as it significantly increases the range of a VLC link.

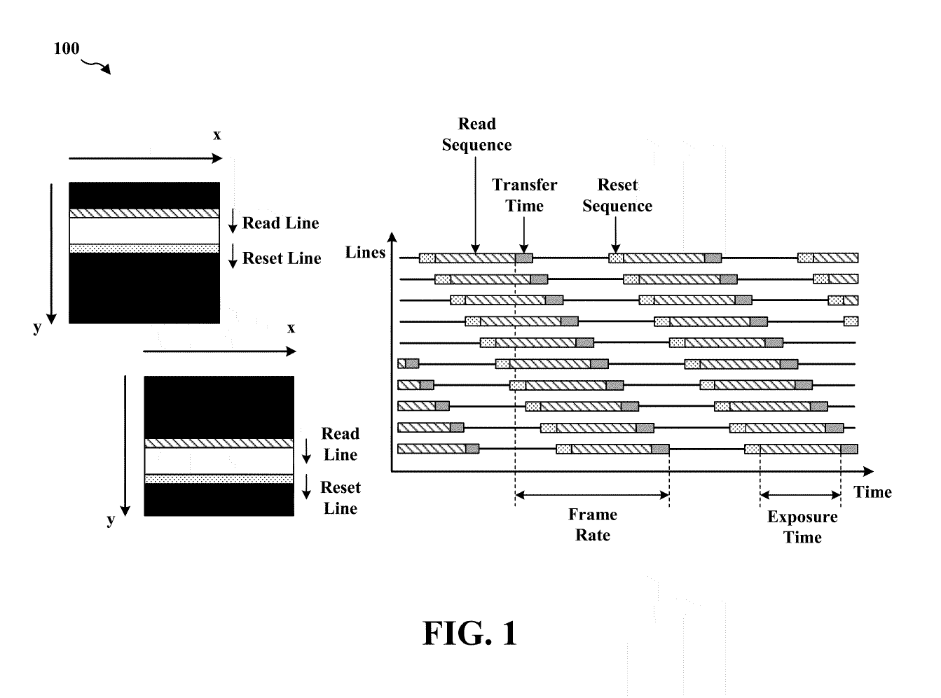

FIG. 1 is a diagram 100 illustrating exposure control in a CMOS image sensor. A CMOS image sensor typically found in commercial devices (e.g., smartphones and tablets) employs an electronic shutter which reads/captures an image one line (row) at a time. Exposure control may be achieved by adjusting a number of sensor rows between rows on which read and reset operations are conducted. The rows in between the rows in which the read and reset operations are conducted are simultaneously exposed to light. A time duration between the read and reset operations may be referred to as a shutter time. The shutter time may be expressed in terms of time units (e.g., fractions of a second) or a number of rows that are simultaneously exposed to light. CMOS sensors are designed for photography, hence exposure is normally controlled by an Automatic Exposure Control algorithm which attempts to adjust exposure levels to ensure that the captured image is bright enough for human perception. Typically, a darker scene requires a longer exposure time for each line of a sensor array. However, since a read-out rate of the lines may be constant over time, an increased exposure time may be achieved by exposing multiple lines at the same time. The number of lines exposed at any given time may be an integer parameter N.

A VLC signal, captured by the image sensor, may be characterized by pixel intensity modulation across the lines of the sensor array. Hence, an N-line exposure setting may have an attenuating effect on the received VLC signal components whose frequencies are greater than the bandwidth of an integrating filter (which is inversely proportional to the number of exposure lines N). For example, if the number of lines of exposure N is 100 and the line sampling rate of the image sensor is 40 KHz (which is the case for a 2 Megapixel camera running at 30 frames per second), the 3-dB bandwidth (cutoff frequency) of the integrating filter is 200 Hz (40 KHz/(2*100)=200 Hz).

In an aspect, a number of image sensor lines N that are exposed at any particular time should be as small as possible to ensure that high frequency VLC signals are not attenuated. In an implementation, a value of N that is conducive for detection of VLC signals is 1 but could range anywhere from 1 to less than 100. For typical photography applications, the value of N may be approximately 100 or more. The present disclosure provides a method and apparatus for adjusting exposure settings of the image sensor based upon whether the mobile device is in a mode for decoding a VLC signal or a mode for capturing a regular photograph.

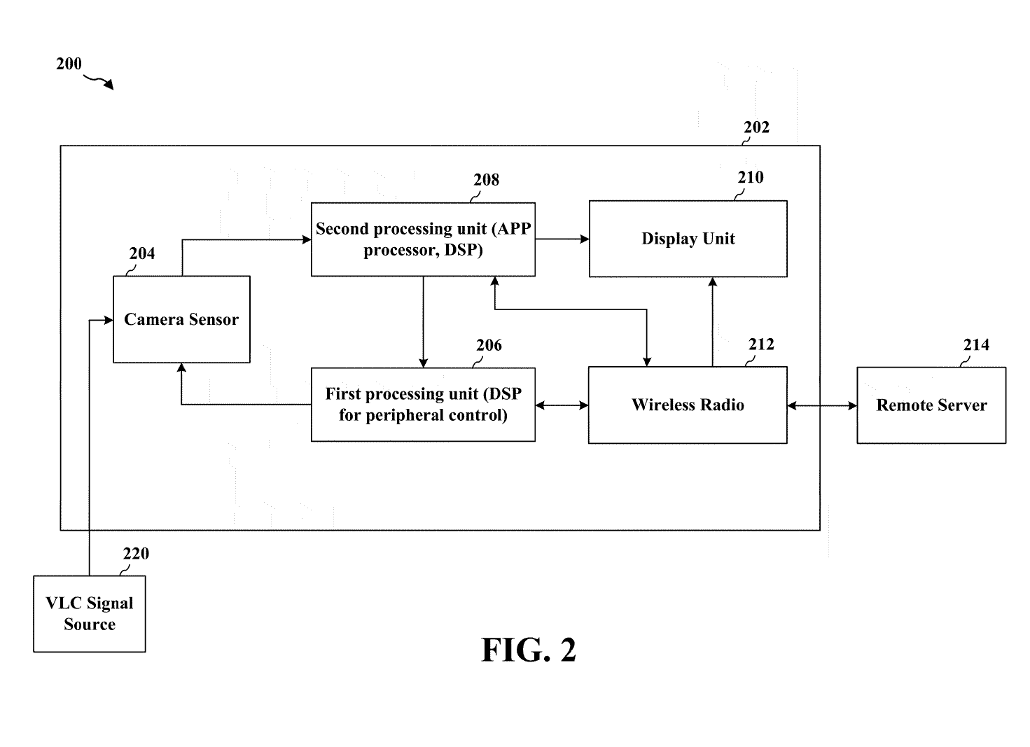

FIG. 2 is a diagram 200 illustrating hardware units within a mobile device 202 and a signal flow between the hardware units for enabling VLC decoding. A camera sensor 204 may initially be set at an exposure setting appropriate for photography/video recording. A first processing unit 206 may be a digital signal processor (DSP) used for controlling mobile device peripheral units such as the camera sensor 204. The first processing unit 206 may configure exposure settings for VLC. For example, the first processing unit 206 may determine whether to trigger a VLC receiver mode of operation. If the VLC receiver mode of operation is triggered, the first processing unit 206 transmits a signal to the camera sensor 204. The signal may carry a message instructing the camera sensor 204 to change an exposure setting (e.g., enable a low exposure setting mode). Upon enabling a low exposure setting, the camera sensor 204 may capture at least one frame of a VLC signal from a VLC signal source 220 (e.g., LED, Laser Diode, etc.) and transmit the contents of the at least one captured frame to a second processing unit 208. The VLC signal frame may include communication symbols (bits) associated with an encoded message from the VLC signal source 220. The second processing unit 208 may be different from the first processing unit 206 that transmitted the instruction to change the exposure setting (e.g., instruction to enable the low exposure setting mode). The second processing unit 208 may be an applications (APP) processor or DSP, for example. The camera sensor 204 may proceed to capture VLC signal frames until a certain frame count is reached or until a signal from the first processing unit 206 instructing the camera sensor 204 to terminate frame capture is received. During frame capture under the low exposure setting, the camera sensor 204 may be unable to capture regular photographic/video images.

The second processing unit 208 may detect the presence of communication symbols (bits) in the captured VLC signal frame(s) and decode a message by performing a VLC signal decoding operation on the detected communication symbols. For example, the second processing unit 208 may detect communication symbols/bits from on-off pulse positions in a captured VLC signal frame. After the image sensor 204/second processing unit 208 has accumulated a sufficient number of the symbols/bits, the second processing unit 208 may decode the symbols/bits to yield the message that was transmitted. The message may be, e.g., a MAC address or a URL link, and may have a length of 48 bits. In some implementations, the message may be shorter or longer than 48 bits. Upon completing the message decoding, the second processing unit 208 may transmit a first completion signal to the first processing unit 206. The first processing unit 206 may then transmit a second completion signal to the camera sensor 204 upon receiving the first completion signal from the second processing unit 208. Upon receiving the second completion signal, the camera sensor 204 may revert back to the exposure setting appropriate for photography/video recording. The exposure setting appropriate for photography/video recording may have a value higher than a value of the exposure setting required for VLC signal capturing.

Based on the result of the VLC decoding operation performed by the second processing unit 208, a number of other hardware units within the mobile device 202 may be activated. For example, a display unit 210 may be used to display/report user information (e.g., user location) based on a VLC signal or a decoded message corresponding to that VLC signal. In another example, a wireless radio 212 (WLAN or WAN) may be used to transmit a signal to a remote server 214. The signal transmitted from the wireless radio 212 may contain information related to the decoded VLC signal with the purpose of receiving information from the remote server 214 relevant to the decoded VLC signal (e.g., VLC signal location or related content). The mobile device 202 may then receive information from the remote server 214 in response to the signal sent to the remote server 214. For example, a VLC terminal (mobile device 202) may contact the remote server 214 to receive information corresponding to a message that the VLC terminal decoded from captured VLC frames. The information may be a location/position, URL address, video stream or file, etc. In an example implementation, network providers on a public access WLAN/WAN may limit access to devices that are physically located in a building by activating the WLAN/WAN link through a VLC communication.

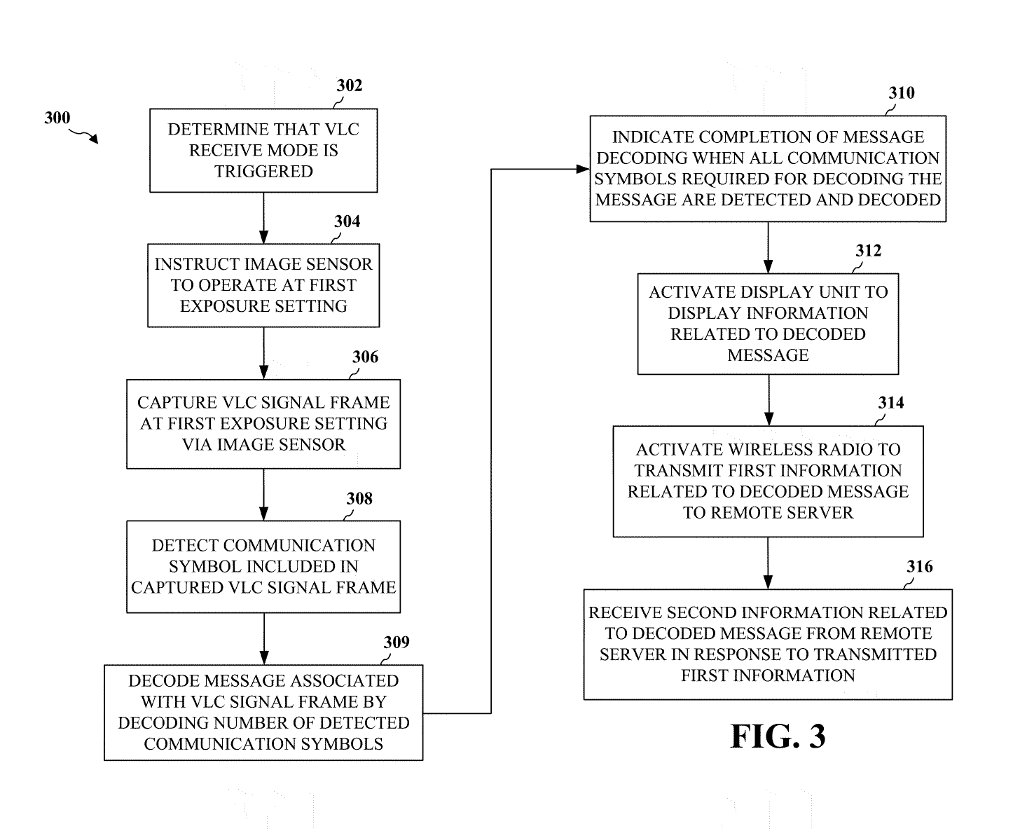

FIG. 3 is a flow chart 300 of configuring an image sensor for processing a visible light communication (VLC) signal. The method may be performed by a device or user equipment (UE) (e.g., mobile device 202 of FIG. 2). At step 302, the device determines that a VLC receive mode for capturing VLC signal frames is triggered. The VLC receive mode may be triggered based on various techniques including a user input to a device housing the image sensor, a physical orientation of the device, a signal received via a wireless radio indicating a presence of at least one VLC signal, and the like.

At step 304, the device instructs the image sensor to operate at a first exposure setting. The first exposure setting may be lower than a second exposure setting for capturing a photographic image. In an aspect, the image sensor may initially be set at the second exposure setting. Accordingly, the image sensor may be instructed to operate at the first exposure setting when the VLC mode is triggered. In an example, when the image sensor is initially set at the second exposure setting, 100 or more lines of an image sensor array may be set to capture the photographic image. When the VLC mode is triggered and the image sensor is instructed to operate at the first exposure setting, a number of lines less than 100 of the image sensor array may be set to capture a VLC signal frame. In an aspect, setting the image sensor array to a least number of lines (e.g., one line) may be most conducive for capturing the VLC signal frame. In a further aspect, exposure settings for capturing the photographic image may vary according to an automatic exposure control (AEC) algorithm implemented by the device and/or the image sensor. The AEC algorithm automatically calculates and adjusts exposure settings to match (as closely as possible) a subject's mid-tone to a mid-tone of the photograph. Accordingly, when the AEC algorithm is implemented, a VLC exposure setting for capturing a VLC signal frame associated with a subject may be any exposure setting less than a value of a photographic exposure setting determined by the AEC algorithm for capturing a photographic image of the subject. In an implementation, at step 304, the second exposure setting for capturing the photographic image may be determined by the AEC algorithm. The AEC algorithm may be disabled prior to the image sensor being instructed to operate at the first exposure setting for capturing a VLC signal frame.

At step 306, the device captures at least one VLC signal frame at the first exposure setting via the image sensor. The image sensor may capture the at least one VLC signal frame from a VLC signal source until a maximum frame count is reached or until the device transmits an instruction to the image sensor to terminate frame capture. The at least one VLC signal frame includes communication symbols associated with an encoded message from the VLC signal source. Moreover, the image sensor is unable to capture the photographic image at the second exposure setting when the image sensor operates at the first exposure setting to capture the at least one VLC signal frame. In an aspect, the image sensor is unable to capture the photographic image when the image sensor operates at an exposure setting below a threshold.

At step 308, the device detects a presence of at least one communication symbol included in the at least one VLC signal frame captured by the image sensor. At step 309, the device decodes a message associated with the at least one VLC signal frame captured by the image sensor by decoding a number of detected communication symbols. At step 310, the device may indicate to the image sensor completion of message decoding when all communication symbols required for decoding the message are detected and decoded. Accordingly, the image sensor may revert back to the second exposure setting upon receiving the indication.

At step 312, the device may activate a display unit to display information (e.g., device location) related to the at least one VLC signal frame or the decoded message corresponding to the at least one VLC signal frame. At step 314, the device may activate a wireless radio to transmit first information related to the at least one VLC signal frame or decoded message (e.g., VLC signal location or related content) to a remote server. At step 316, the device may receive from the remote server, in response to the transmitted first information, second information related to the at least one VLC signal frame or decoded message.

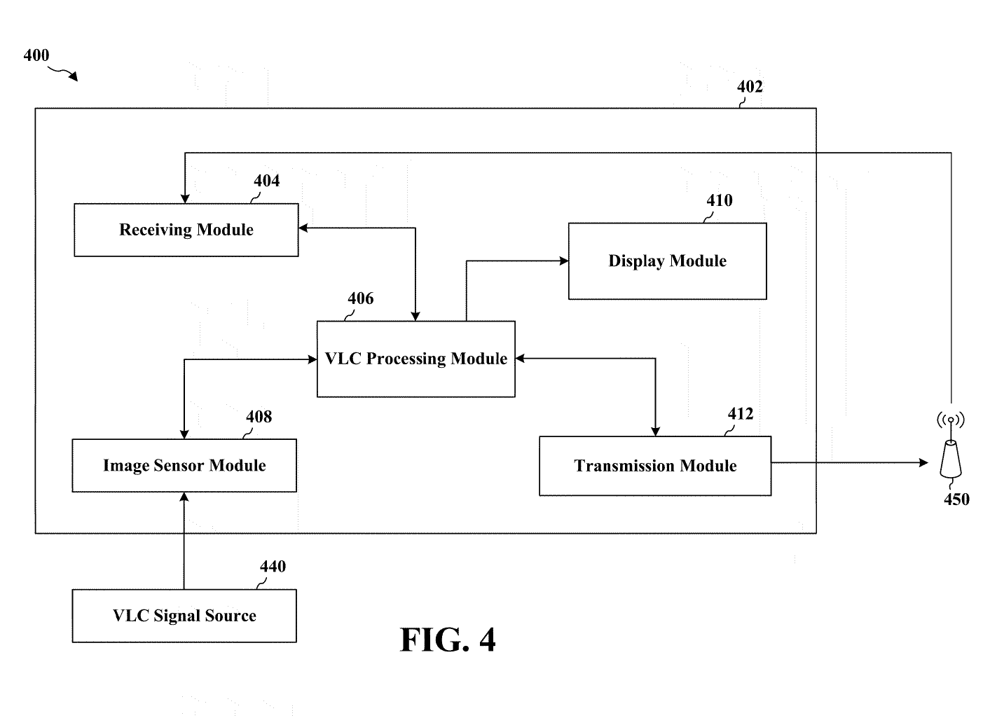

FIG. 4 is a data flow diagram 400 illustrating the data flow between different modules/means/components in an exemplary apparatus 402 configuring an image sensor for processing a visible light communication (VLC) signal. The apparatus may be a device or user equipment (UE) (e.g., mobile device 202 of FIG. 2). The apparatus includes a receiving module 404, a VLC processing module 406, an image sensor module 408, a display module 410, and a transmission module 412. The VLC processing module 406 may be equivalent to, or configured to operate with, the first processing unit 206 and/or the second processing unit 208. The image sensor module 408 may be equivalent to, or configured to operate with, the camera sensor 204. The display module 410 may be equivalent to, or configured to operate with, the display unit 210. The receiving module 404 and the transmission module 412 may be equivalent to, or configured to operate with, the wireless radio 212.

The VLC processing module 406 determines that a VLC receive mode for capturing VLC signal frames is triggered. The VLC receive mode may be triggered based on various techniques including a user input to the apparatus 402, a physical orientation of the apparatus 402, a signal received via the receiving module 404 indicating a presence of at least one VLC signal, and the like.

The VLC processing module 406 instructs the image sensor module 408 to operate at a first exposure setting. The first exposure setting may be lower than a second exposure setting for capturing a photographic image. In an aspect, the image sensor module 408 may initially be set at the second exposure setting. Accordingly, the image sensor module 408 may be instructed to operate at the first exposure setting when the VLC mode is triggered.

The VLC processing module 406 captures at least one VLC signal frame at the first exposure setting via the image sensor module 408. The image sensor module 408 may capture the at least one VLC signal frame from a VLC signal source 440 until a maximum frame count is reached or until the VLC processing module 406 transmits an instruction to the image sensor module 408 to terminate frame capture. The at least one VLC signal frame includes communication symbols associated with an encoded message from the VLC signal source 440. Moreover, the image sensor module 408 is unable to capture the photographic image at the second exposure setting when the image sensor module 408 operates at the first exposure setting to capture the at least one VLC signal frame. In an aspect, the image sensor module 408 is unable to capture the photographic image when the image sensor module 408 operates at an exposure setting below a threshold.

The VLC processing module 406 detects a presence of at least one communication symbol included in the at least one VLC signal frame captured by the image sensor module 408 and decodes a message associated with the at least one VLC signal frame captured by the image sensor module 408 by decoding a number of detected communication symbols. The VLC processing module 406 may indicate to the image sensor module 408 completion of message decoding when all communication symbols required for decoding the message are detected and decoded. Accordingly, the image sensor module 408 may revert back to the second exposure setting upon receiving the indication.

The VLC processing module 406 may activate a display module 410 to display information related to the at least one VLC signal frame or the decoded message corresponding to the at least one VLC signal frame. The VLC processing module 406 may activate a transmission module 412 to transmit first information related to the at least one VLC signal frame or decoded message (e.g., VLC signal location or related content) to a remote server 450. The VLC processing module 406 may receive from the remote server 450 (via the receiving module 404), in response to the transmitted first information, second information related to the at least one VLC signal frame or decoded message.

The apparatus may include additional modules that perform each of the steps of the algorithm in the aforementioned flow chart of FIG. 3. As such, each step in the aforementioned flow chart of FIG. 3 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

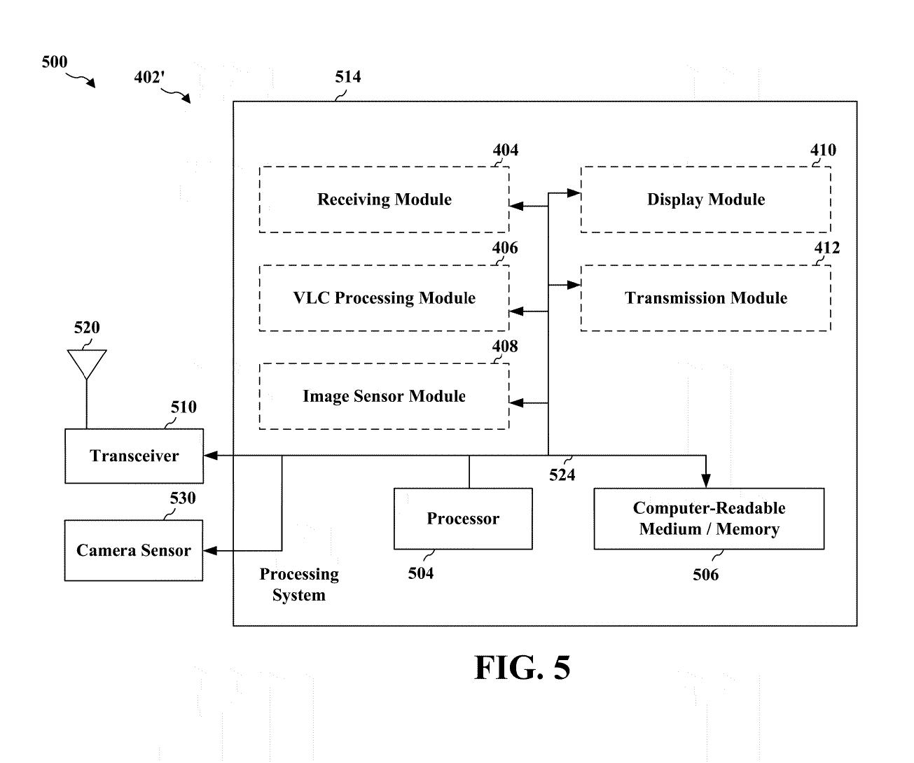

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware modules, represented by the processor 504, the modules 404, 406, 408, 410, 412, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510 and a camera sensor 530. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the receiving module 404. In addition, the transceiver 510 receives information from the processing system 514, specifically the transmission module 412, and based on the received information, generates a signal to be applied to the one or more antennas 520. The camera sensor 530 provides a means for capturing VLC signal frames. The camera sensor 530 captures a VLC signal frame from a light source, extracts information from the captured VLC signal frame, and provides the extracted information to the processing system 514, specifically the image sensor module 408. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system further includes at least one of the modules 404, 406, 408, 410, and 412. The modules may be software modules running in the processor 504, resident/stored in the computer readable medium/memory 506, one or more hardware modules coupled to the processor 504, or some combination thereof.

In one configuration, the apparatus 402/402′ includes means for instructing the image sensor to operate at a first exposure setting, the first exposure setting lower than a second exposure setting for capturing a photographic image, means for capturing, via the image sensor, at least one VLC signal frame at the first exposure setting, means for detecting at least one communication symbol included in the at least one captured VLC signal frame, means for decoding a message associated with the at least one VLC signal frame captured by the image sensor by decoding a number of detected communication symbols, wherein the image sensor is initially set at the second exposure setting, means for determining that a VLC receive mode for capturing VLC signal frames is triggered, wherein the means for instructing instructs the image sensor to operate at the first exposure setting when the VLC receive mode is triggered, means for indicating to the image sensor completion of message decoding when all communication symbols required for decoding the message are detected and decoded, wherein the image sensor reverts back to the second exposure setting upon receiving the indication, means for activating a display unit to display information related to the decoded message, means for activating a wireless radio to transmit first information related to the decoded message to a remote server, and means for receiving from the remote server, in response to the transmitted first information, second information related to the decoded message. The aforementioned means may be one or more of the aforementioned modules of the apparatus 402 and/or the processing system 514 of the apparatus 402′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of configuring an image sensor for processing a visible light communication (VLC) signal, comprising:
instructing the image sensor to operate at a first exposure setting, the first exposure setting lower than a second exposure setting for capturing a photographic image;
capturing, via the image sensor, at least one VLC signal frame at the first exposure setting; and
detecting at least one communication symbol included in the at least one captured VLC signal frame.

2. The method of claim 1, further comprising:
decoding a message associated with the at least one VLC signal frame captured by the image sensor by decoding a number of detected communication symbols.

3. The method of claim 2, wherein the image sensor is initially set at the second exposure setting, the method further comprising:
determining that a VLC receive mode for capturing VLC signal frames is triggered,
wherein the image sensor is instructed to operate at the first exposure setting when the VLC receive mode is triggered.

4. The method of claim 3, wherein:
the second exposure setting is initially set according to an automatic exposure control (AEC) algorithm; and
the AEC algorithm is disabled prior to the image sensor being instructed to operate at the first exposure setting.

5. The method of claim 3, further comprising:
indicating to the image sensor completion of message decoding when all communication symbols required for decoding the message are detected and decoded,
wherein the image sensor reverts back to the second exposure setting upon receiving the indication.

6. The method of claim 3, wherein the VLC receive mode is triggered based on at least one of:
a user input to a device housing the image sensor;
a physical orientation of the device housing the image sensor; or
a signal received via a wireless radio indicating a presence of at least one VLC signal.

7. The method of claim 2, further comprising:
activating a display unit to display information related to the decoded message.

8. The method of claim 2, further comprising:
activating a wireless radio to transmit first information related to the decoded message to a remote server; and
receiving from the remote server, in response to the transmitted first information, second information related to the decoded message.

9. The method of claim 1, wherein the image sensor captures the at least one VLC signal frame until a maximum frame count is reached or until the image sensor receives an instruction to terminate frame capture.

10. The method of claim 1, wherein the image sensor is unable to capture the photographic image at the second exposure setting when the image sensor operates at the first exposure setting to capture the at least one VLC signal frame.

11. The method of claim 1, wherein the image sensor is unable to capture the photographic image when the image sensor operates at an exposure setting below a threshold.

12. An apparatus for configuring an image sensor for processing a visible light communication (VLC) signal, comprising:
means for instructing the image sensor to operate at a first exposure setting, the first exposure setting lower than a second exposure setting for capturing a photographic image;
means for capturing, via the image sensor, at least one VLC signal frame at the first exposure setting; and
means for detecting at least one communication symbol included in the at least one captured VLC signal frame.

13. The apparatus of claim 12, further comprising:
means for decoding a message associated with the at least one VLC signal frame captured by the image sensor by decoding a number of detected communication symbols.

14. The apparatus of claim 13, wherein the image sensor is initially set at the second exposure setting, the apparatus further comprising:
means for determining that a VLC receive mode for capturing VLC signal frames is triggered,
wherein the means for instructing instructs the image sensor to operate at the first exposure setting when the VLC receive mode is triggered.

15. The apparatus of claim 14, wherein:
the second exposure setting is initially set according to an automatic exposure control (AEC) algorithm; and
the AEC algorithm is disabled prior to the image sensor being instructed to operate at the first exposure setting.

16. The apparatus of claim 14, further comprising:
means for indicating to the image sensor completion of message decoding when all communication symbols required for decoding the message are detected and decoded,
wherein the image sensor reverts back to the second exposure setting upon receiving the indication.

17. The apparatus of claim 14, wherein the VLC receive mode is triggered based on at least one of:
a user input to a device housing the image sensor;
a physical orientation of the device housing the image sensor; or
a signal received via a wireless radio indicating a presence of at least one VLC signal.

18. The apparatus of claim 13, further comprising:
means for activating a display unit to display information related to the decoded message.

19. The apparatus of claim 13, further comprising:
means for activating a wireless radio to transmit first information related to the decoded message to a remote server; and
means for receiving from the remote server, in response to the transmitted first information, second information related to the decoded message.

20. The apparatus of claim 12, wherein the image sensor captures the at least one VLC signal frame until a maximum frame count is reached or until the image sensor receives an instruction to terminate frame capture.

21. The apparatus of claim 12, wherein the image sensor is unable to capture the photographic image at the second exposure setting when the image sensor operates at the first exposure setting to capture the at least one VLC signal frame.

22. The apparatus of claim 12, wherein the image sensor is unable to capture the photographic image when the image sensor operates at an exposure setting below a threshold.

23. An apparatus for configuring an image sensor for processing a visible light communication (VLC) signal, comprising:
a memory; and
at least one processor coupled to the memory and configured to:
instruct the image sensor to operate at a first exposure setting, the first exposure setting lower than a second exposure setting for capturing a photographic image;
capture, via the image sensor, at least one VLC signal frame at the first exposure setting; and
detect at least one communication symbol included in the at least one captured VLC signal frame.

24. The apparatus of claim 23, the at least one processor further configured to:
decode a message associated with the at least one VLC signal frame captured by the image sensor by decoding a number of detected communication symbols.

25. The apparatus of claim 24, wherein the image sensor is initially set at the second exposure setting, the at least one processor further configured to:
determine that a VLC receive mode for capturing VLC signal frames is triggered,
wherein the at least one processor instructs the image sensor to operate at the first exposure setting when the VLC receive mode is triggered.

26. The apparatus of claim 25, the at least one processor further configured to:
indicate to the image sensor completion of message decoding when all communication symbols required for decoding the message are detected and decoded,
wherein the image sensor reverts back to the second exposure setting upon receiving the indication.

27. The apparatus of claim 25, wherein the VLC receive mode is triggered based on at least one of:
a user input to a device housing the image sensor;
a physical orientation of the device housing the image sensor; or
a signal received via a wireless radio indicating a presence of at least one VLC signal.

28. The apparatus of claim 24, the at least one processor further configured to:
activate a wireless radio to transmit first information related to the decoded message to a remote server; and
receive from the remote server, in response to the transmitted first information, second information related to the decoded message.

29. The apparatus of claim 23, wherein the image sensor captures the at least one VLC signal frame until a maximum frame count is reached or until the image sensor receives an instruction to terminate frame capture.

30. A computer-readable medium for configuring an image sensor for processing a visible light communication (VLC) signal, comprising code for:
instructing the image sensor to operate at a first exposure setting, the first exposure setting lower than a second exposure setting for capturing a photographic image;
capturing, via the image sensor, at least one VLC signal frame at the first exposure setting; and
detecting at least one communication symbol included in the at least one captured VLC signal frame.
